(19) United States
(12) Patent Application Publication
(10) Pub. No.: US 2012/0311865 A1
(43) Pub. Date: Dec. 13, 2012

(54) MINERAL BLADE AND RAZOR FOR USE WITH SAME

(75) Inventors: HAYDEN HAMILTON, Portland, OR (US); RYAN McCARTHY, Portland, OR (US); SIRI M. KHALSA, Portland, OR (US); JACLYN KAMPMEIER, Apo, AP (US); JONATHAN MORRIS, Portland, OR (US); CARL ALVIANI, Portland, OR (US); GRAEME WAGONER-LYNCH, Portland, OR (US); JAMES KELLERMAN, Portland, OR (US)

(73) Assignee: ZAFIRRO, LLC, Portland, OR (US)

(21) Appl. No.: 13/492,405

(22) Filed: Jun. 8, 2012

Related U.S. Application Data
(60) Provisional application No. 61/494,722, filed on Jun. 8, 2011.

(51) Int. Cl. B26B 21/00; B26B 21/20; H05H 1/00; B26B 21/58; B23K 26/00; B26B 21/16; B26B 21/52

(52) U.S. Cl. 30/50; 30/346.5; 30/346.53; 30/527; 30/32; 219/227

(57) ABSTRACT

Disclosed is a razor blade having a mineral blade with a mineral cutting edge, with the mineral cutting edge having a radius of less than about 20 nanometers and an angle of about 40-50 degrees and wherein the mineral blade is coated in an adhesion promoter and an outer layer and a method of making the razor blade. Also disclosed is a razor having a mineral blade, and a method of making the razor.

### CROSS REFERENCE TO RELATED APPLICATIONS

This application claims priority to U.S. Patent Application No. 61/494,722, filed Jun. 8, 2011, which is herein incorporated by reference in its entirety.

### FIELD OF THE INVENTION

The present invention relates generally to a mineral blade and a non-disposable razor for use with same, and methods for making the mineral blade and the non-disposable razor.

### BACKGROUND

Handheld non-electric razors have been available for many years and may be found in a number of different shapes and sizes as well as in disposable and non-disposable formats. As disclosed herein, a razor is defined as a self-contained shaving unit having a least one razor blade, a cartridge, a head and a handle. The cartridge maintains the blade or blades in a pre-determined shaving position. The blade or blades may be formed of a suitable substrate material such as stainless steel and a cutting edge is formed with a wedge-shaped configuration with an ultimate tip having a radius of less than about 1,000 angstroms, usually about 200-300 angstroms. Hard coatings such as diamond, amorphous diamond, diamond-like carbon (DLC) material, nitrides, carbides, oxides or ceramics are often used to improve strength, corrosion resistance and shaving ability, maintaining needed strength while permitting inner edges with lower cutting forces to be used.

Typical modern shaving razor blades incorporate a substrate of stainless steel, such as iron and chromium—containing martensitic stainless steel, together with a hard coating of chromium or chromium nitride overlying the stainless steel substrate at least along the cutting edge of the blade.

A coating of a fluoropolymer lubricant such as polytetrafluoroethylene (PTFE) overlies the hard coating. The hard coating is normally applied by a process known as sputtering. Sputtering ordinarily is conducted under a controlled atmosphere, typically a noble gas at extremely low pressures. Following the sputtering process, the semi-finished blade or blades, with the hard coating, are removed from the controlled atmosphere. The blades are coated with the lubricant by applying a dispersion of the fluorocarbonpolymer and a liquid solvent, evaporating off the solvent and then fusing the remaining lubricant by heating to above the melting point of the polymer.

One avenue of research in the razor art has been directed toward the development of a hard coating which could be used as a substitute for stainless steel and chromium in the blade. Ordinary cutting tools become dull and unusable due to gradual abrasive wear of their cutting edges. In use, the ultimate tip of the edges having hard coatings and PTFE outer layers can become more rounded after repeated shaves such that there is an increase in the tip radius and generally perceived decrease in shaving performance. Razors incorporating blades according to this general construction have been regarded previously as adequate in that they provide a good combination of shaving performance, durability and low cost. Nonetheless, there have been needs for still further improvements as these known blades have a relatively short usable life span and become dull relatively quickly.

What is needed in the industry is a razor, and more particularly, a razor blade comprised of materials that allow the blade to maintain its sharp edge and performance over an extended number of shaves. In order to improve the chemical and mechanical properties of a substance, its hardness, wear resistance, corrosion resistance, and fatigue resistance, the substrate, such as one used for the razor blade, have hard coatings applied to the substrate, particularly at the cutting edge. For razor blades these hard coatings serve two major roles. Namely, to strengthen the razor blade, which allows for slimmer profiles, and to provide a suitable interface with the adhesion of a lubricant coating, such as PTFE. Generally, the thinner the razor blade becomes at its cutting edge the lower the cutting force and the better the razor blade's cutting attributes. The properties of the resulting razor blade greatly depend on the strength and the hardness of both the underlying substrate and the coating. Up until the development of embodiments of the present invention, suitable blade substrates and coatings providing these advantages were not known in the art.

### SUMMARY

Embodiments of the present invention are razor blades and a razor and methods of making them with novel and non-obvious features permitting extended use of the razor and blades and thus reducing waste.

An embodiment is a razor blade comprising a mineral substrate, an adhesion promoter first surface bound to the mineral substrate, and an outer layer bound to a second surface the adhesion promoter. The mineral substrate may be corundum, sapphire, ruby and diamond or a combination thereof. The adhesion promoter first surface comprises a substrate binding group and the second surface comprises an outer layer binding group. The adhesion promoter substrate binding group may comprise a silane and/or phosphonate. The adhesion promoter outer layer binding group may comprise a halogen and/or an amine. The outer layer is a lubricious fluoropolymer, including, but not limited to, PTFE.

An embodiment is a razor blade comprising a mineral blade with a mineral cutting edge, the mineral cutting edge having a radius of less than about 20 nanometers and an angle of about 40-50 degrees, wherein the mineral blade is coated in about 20 nanometers of the adhesion promoter and at least about 400 nanometers of the outer layer. The mineral may be a corundum such as a single crystal sapphire, ruby, or diamond. The mineral blade may be about 0.2 millimeters thick, when used in conjunction with the razor according to an embodiment of the present invention Thickness as well as width of the blade may vary greatly depending upon the application, single blade, at least two blades, or use of the blade in a straight razor.

In one embodiment, the mineral blade may be annealed before coating with chromium nitride and the mineral cutting edge is sharpened by treating with at least one of plasma and laser. The chromium nitride coating may be applied by magnetron sputtering, and following the coating with chromium nitride the blade may be annealed in an argon atmosphere. A portion of the chromium nitride coating may be diffused into the mineral blade. The PTFE may be spray applied and sintered in an inert atmosphere onto the surface of the chromium nitride coated mineral blade.

An embodiment is a razor comprising at least one mineral blade further comprising a head having a first surface and a second surface, a cartridge having a cartridge top having a first surface and a second surface and a cartridge bottom having a first surface and a second surface, wherein the blade is disposed between the second surface of the cartridge top and the first surface of the cartridge bottom, wherein the first surface of the cartridge top is removably attached to the second surface of the head, and a handle, wherein the head is movably attached by a pivot pin to a first end of the handle. The first surface of the cartridge top is removably attached to the second surface of the head using at least one magnet.

The handle may be comprised of a left piece having an internal and an external surface, a right piece having an internal and an external surface, and a center piece, wherein the center piece is disposed between the internal surface of the left piece and the internal surface of the right piece. The cartridge may be comprised of a cartridge top having a first surface and a second surface, a cartridge bottom having a first surface and a second surface, wherein the blade is disposed between the second surface of the cartridge top and the first surface of the cartridge bottom, wherein the cartridge top is attached to the cartridge bottom using at least two micro-screws, and wherein at least one cavity is disposed in the first surface of the cartridge top, wherein the cavity is adapted to receive at least one magnet. The magnet may be a rare earth magnet and may be, but is not limited to, a nickel-plated rare earth magnet. At least one first magnet may be disposed on the second surface of the head and at least one second magnet of opposite polar orientation from the first magnet may be disposed on the first surface of the cartridge top. The center piece may be comprised of iridium, and the razor may comprise at least one mineral blade. The mineral blade may comprise corundum, sapphire, ruby, diamond, or any combination thereof.

Additional advantages of an embodiment of the invention will be set forth in part in the description that follows, and in part will be obvious from the description, or may be learned by practice of the invention. The advantages of the invention will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments of the invention and with the description, serve to explain the principles of the invention. Where appropriate, the same reference numerals refer to the same or similar elements.

FIG. 1 is an elevation view of a razor blade according to an embodiment of the present invention.

FIG. 2 is an elevation view of a razor blade according to an embodiment of the present invention.

FIG. 3 is an elevation view of a razor blade according to an embodiment of the present invention.

FIG. 4 is an elevation view of a razor blade according to an embodiment of the present invention.

FIG. 5 is an exploded view of a razor according to an embodiment of the present invention.

FIG. 6 is an elevation view of razor blades as fixed in a cartridge according to an embodiment of the present invention.

### DETAILED DESCRIPTION OF EMBODIMENTS OF THE INVENTION

Reference now will be made in detail to the device and methods consistent with implementations of the present invention, examples of which are illustrated in the accompanying drawings. The appended claims define the scope of the invention, and the following description does not limit that scope.

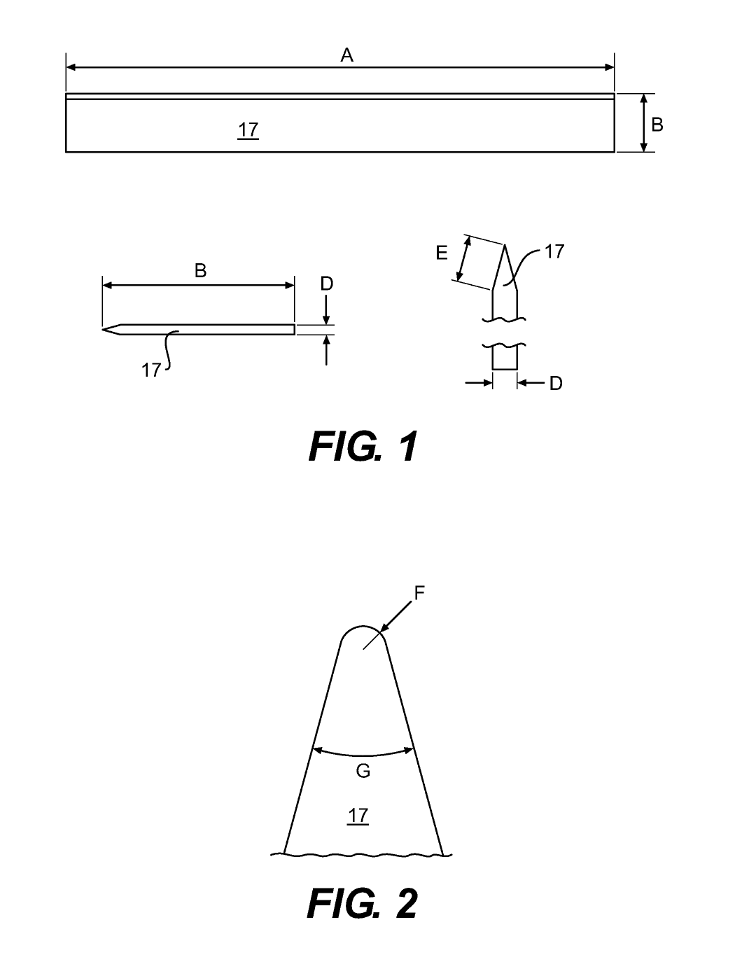

As shown in FIG. 1-4, blade 10 is comprised of substrate 17 then coated with adhesion promoter 18 and subsequently coated with outer layer 19. As shown in FIG. 1, substrate 17 may comprise mineral, corundum, alpha-Al₂O₃, aluminum oxide, alumina, diamond, ruby, or sapphire or any other suitable mineral. Substrate 17 may comprise minerals containing chemical dopants or other impurities, as in the case of corundum and ruby. Substrate 17 may be monocrystalline as cut from from a boule or polycrystalline, as would result from sintering and fusing aluminum oxide under pressure. For purposes of example only, in one embodiment substrate 17 may comprise a sapphire, which may be, but is not limited to, a single crystal sapphire 2 having length A of about 38 mm, and width B may be about 4 mm. Thickness D may be about 0.2 mm. Many other measurements having width B greater than about 4 mm, and thickness D greater than about 0.2 mm are possible depending on whether the razor is mounted as a single-blade or a double blade razor, or even mounted as a straight razor.

As shown in FIGS. 1 and 2, the C (0001) crystal face is disposed on the B×D face, and is mechanically and chemically sharpened on both sides to produce angle G of about 30 degrees. After mechanical and chemical sharpening, the crystal substrate 17 is then annealed to relieve stresses in the crystal. At this stage, the edge radius F is roughly about 100 nm. Length E is driven by the thickness D tolerance combined with the angle G tolerance. Length E may be about 0.30 mm to about 0.50 mm. In one embodiment length E is approximately 0.39 mm.

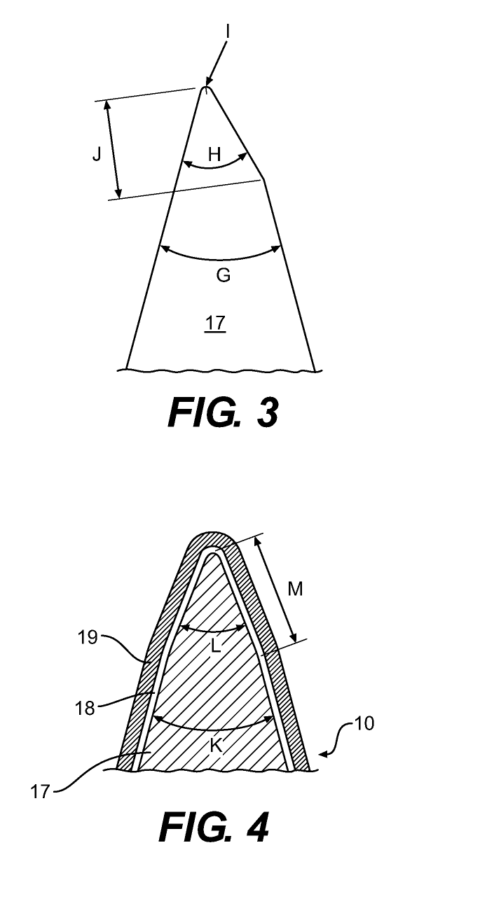

As shown in FIG. 3, substrate 17 may be further sharpened by plasma and/or laser to produce an even sharper cutting edge I of less than about 20 nm edge radius. In one embodiment plasm sharpening may be accomplished by placing blade 10 in a vacuum chamber and then treating them with oxygen or chlorine gas that has been excited to a plasma state. In one embodiment a laser may be used to sharpen blade 10. In addition, a combination of plasma and laser sharpening may be used. This final sharpening step also increases the final angle H to about 40-50 degrees for the final edge J of about 1-1.5 um to increase the durability of the edge. At this stage sharpening of substrate 17 is complete.

As shown in FIG. 4, sharpened substrate 17 is treated with bifunctional adhesion promoter 18. Adhesion promoter 18 comprises a substrate binding group that binds to substrate 17 and an exposed functional group that mediates interaction with outer layer 19. Adhesion promoter 18 may comprise either silane or phosphonate substrate binding chemistry to bind to substrate 17. In the case of silane chemistry, the silane group can be mono-, di- or trialkoxy substituted. A monoalkoxy substituted silane will create an adhesion promoter 4 monolayer about three to about eight layers thick. Monoalkoxy substitution is preferred. At substrate 17 surface while di- or tri-alkoxy substituted silanes will create adhesion promoter 18 multilayer from about three to about eight layers thick. Monoalkoxy substitution is preferred. The silane alkoxy groups can be methoxy, ethoxy, propoxy, isopropoxy or any alkoxy groups based on any higher alcohol, but methoxy and ethoxy are preferred. In the case of phosphonate substrate binding group, an unsubstituted phosphonic acid group can be used or phosphonate mono- or di-substituted with any alkoxy group as described in the above paragraph. Again, methoxy or ethoxy groups are preferred.

Adhesion promoter 18 exposed functional group is attached to the substrate binding group by an aromatic and/or alkane spacer. In the case of an alkane, it can be of any length but for purposes of stability, a propyl group is preferred. The exposed functional group can be either a halogen or an amine. In the case of a halogen, a chloro-group is preferred. In the case of amine, it can be a primary or secondary amine or any combination of amines linked by an alkane spacer or spacers. Adhesion promoter 18 is then cured according to its substrate binding group's chemistry. Curing processes are known to ones of ordinary skill in the art and the conditions need not be repeated here. In the case or silane curing chemistry, the treatment may comprise a about 5 to about 10 minute curing at about 110 degrees C. In the case of phosphonate chemistry, curing consists immersing in solution for about 24 hours then dried, procedures that are known to one of ordinary skill in the art.

The subsequent application of outer layer 19, which may be, but is not limited to, a polyamide-imide/fluoropolymer (PAI) layer may be accomplished with the PAI applied as a primer or co-sprayed as a mix of commercially available PAI resin and commercially available fluoropolymer dispersion or suspended micropowder. The PAI layer may comprise PAI available from a number of commercial sources. The solvent can be water or organic solvent. The fluoropolymer is preferably polytetrafluoroethylene (PTFE) but any acceptably lubricious fluoropolymer can be substituted. Finally, the coated blade undergoes a curing heat treatment. Curing of the outer layer coating is accomplished first by drying at 95 degrees C. for 10 minutes and then with a bake at 420 degrees C. for 10 minutes. The curing process: 1) evaporates the solvent; 2) converts the polyamic acid in PAI resin to its final polyamide-imide form, giving the PAI its toughness; and 3) sintering of PTFE to create adhesion with the PAI resin as well as create a continuous outer layer of fluoropolymer film.

In a first embodiment adhesion promoter 18 may be an alkene or alkyne adhesion promoter and outer layer 19 may be PTFE deposited via initiated Chemical Vapor Deposition (iCVD). Substrate 17 is first coated with bifunctional adhesion promoter 18. The exposed functional group is preferably an alkene or alkyne. Any group containing a carbon-carbon multiple bond is acceptable. Some examples are vinyl, allyl, propenyl, and vinylbenzyl. A vinyl or allyl group is preferred. Adhesion promoter 18 layer is then cured according to its substrate binding group's chemistry, as discussed above.

The subsequent application of outer layer 19 of PTFE is accomplished through initiated chemical vapor deposition (iCVD). Briefly, this involves the pyrolysis of a fluorinated gaseous compound that yields a difluorocarbene radical. The difluorocabene radical polymerizes into PTFE at the surface of substrate 17 as disclosed in U.S. Pat. No. 6,153,269, which is hereby incorporated by reference in its entirety.

In a second embodiment adhesion promoter 18 is a fluoroalkane and outer layer 19 is iCVD PTFE or sintered PTFE. Substrate 17 is first coated with bifunctional adhesion promoter 18. The exposed functional group comprises an alkane spacer attached to an unbranched fluoroalkane chain. The spacer can be methylene, ethylene, propylene or longer but ethylene is preferred. The fluoroalkane chain can be any length but is preferably between four and twelve CF₂ units in length. Adhesion promoter 18 layer is then cured according to its substrate binding group's chemistry, as discussed above. Curing, for the purposes of the present application, can be implied to be a part of the coating process. The subsequent application of outer layer 19 comprising a fluoropolymer is then accomplished either by conventional spray-sinter methods or by iCVD as described above.

In a third embodiment bare corundum substrate 17, including, but not limited to, sapphire is coated with outer layer 19 which may be iCVD PTFE. Untreated substrate 17 is treated with iCVD procedure to apply outer layer 19 of PTFE material and then heat-sintered as described previously.

In a fourth embodiment, after sharpening, substrate 17 is coated in about 5 nm to about 50 nm, and in one embodiment about 20 nm of adhesion promoter 18, which is, but not limited to, chromium nitride, applied via magnetron sputtering. After this coating is applied, substrate 17 and adhesion promoter 18 are then annealed in an argon atmosphere so as to diffuse the lower portion of the metallic coating into substrate 17. Finally, outer layer 19 of PTFE is spray-applied via atomizer and sintered in an inert atmosphere onto the surface. In one embodiment, final sintered PTFE coating is at least about 100 nm to about 1500 nm and in one embodiment at least about 400 nm thick.

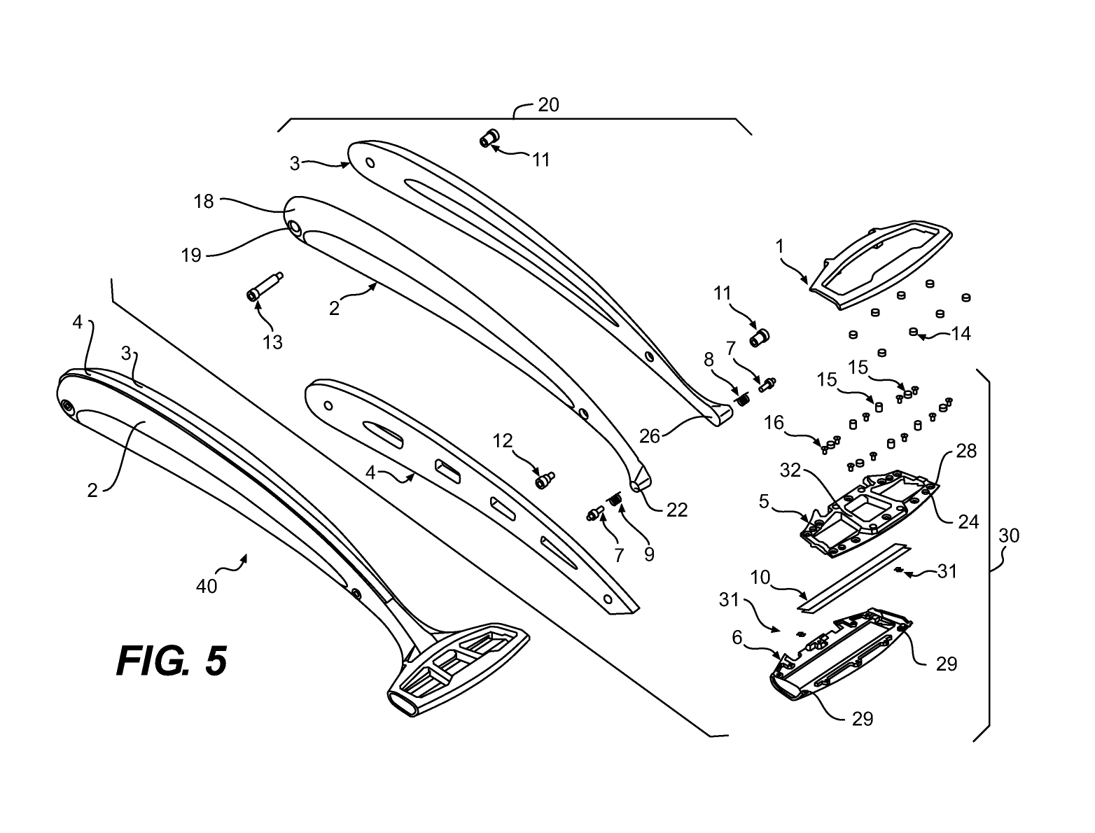

As shown in FIG. 5, blade 10 comprising substrate 17, adhesion promoter 18 and outer layer 19 may be used in conjunction with razor 40 according to one embodiment of the present invention. Razor 40 is comprised of three main sub-assemblies: handle 20, head 1, and cartridge 30. Handle 20 may comprise three separate pieces: first or left handle 3, center piece 4, and second or right handle 2. They are assembled by at least two sets of sexed bolts 12 and 13. Sexed bolt 12 is sized appropriately for placement through structural thru-holes 19 disposed near a first end 26 of handle 20 located proximal to head 1. Sexed bolt 13 is sized appropriately for placement through structural thru-holes 19 disposed near a second end 18 of handle 20 located distal from head 1. Sexed bolts 12, 13 may be comprised of stainless steel or any other suitable material such as, but not limited to, titanium, gold, platinum, and iridium or any combination thereof. Head 1 is attached to first 3 and second 2 handle pieces by pivot pins 7. When sexed bolts 12, 13 are in place, securing first handle 3, second handle 2 and center piece 4 together, head 1 will not be removable from handle 20. The connection between head 1 and handle 20 comprises two pivot pins 7. Near first end 26 of both first 3 and second 2 handle pieces small cavity 22 is disposed and/or milled out to receive torsion spring 8, 9 and pivot pins 7.

Cartridge 30 comprises two frame pieces, cartridge top 5 and cartridge bottom 6, that may be secured together by at least one microscrew 16. Microscrew 16 may be comprised of stainless steel or any other suitable material, including, but not limited to, titanium, platinum, gold and iridium or any combination thereof. Disposed between a second or underside surface of cartridge top 5 and a first or top surface of cartridge bottom 6 is at least one blade 10, prepared as described above. In one embodiment at least two blades 10′ and 10″ may also include a small piece of shock absorbent material 31 disposed between the at least two blades 10. Shock absorbent material 31 may comprise rubber or any other suitable material. The rubber may be, but is not limited to, synthetic rubber, natural rubber, and/or a foam rubber.

Cartridge 30 removably attaches to head 1 by a system of at least one magnet 14, 15. Magnets 14, 15 may be rare earth magnets, or any other suitable magnet. Magnet 14 is disposed and affixed to a second surface or underside of head 1. Magnet 15 is disposed and affixed to a first surface or top surface of cartridge top 5. Magnets 14 and 15 are disposed in cavities 24 found in head 1 and cartridge top 5. The geometry of cartridge 30 and head 1 are complimentary, so that as magnets 14, 15 attract one another and pull together, the top or upper surface of cartridge 30 and the second or underside surface of head 1 mate in such a way to prevent cartridge 30 from shearing off from head 1 during use. Cartridge 30 must be removed from head 1 by overcoming the attractive force of magnets 14, 15 and pulling cartridge 30 away in a direction perpendicular to the longitudinal axis of head 1.

First 3 and second 2 handle pieces are mirror structures of each other. They may be milled/machined from 316 stainless steel or any other suitable material such as, but not limited to, titanium, gold, platinum, and iridium or any combination thereof and may be machine polished to a satin finish. Two sets of structural thru-holes 19, one disposed near first end 26 and the other disposed near second end 18 of handle 20, serve as the location for sexed bolts 12, 13 and female screw 11 for assembly of handle 20. Female screw 11 may be a removable thread-locker screw. To reduce weight and improve balance of handle 20 there may be a large tear-shaped opening disposed along a portion of the length of handle 20 between the two structural holes 19.

Center piece 4 may be flat, and machined/milled from high purity iridium, or any other suitable material, such as, but not limited to, stainless steel, titanium, gold, and platinum or any combination thereof. Iridium is very strong, rare, and difficult to work with. Center piece 4 may be polished to a bright/near-mirror finish. Center piece 4 has at least one, and in one embodiment, two structural thru-holes 19, one disposed near first end 26 and the other disposed near second end 18 of handle 20, which align with thru-holes 19 disposed on left 3 and right 2 handle pieces when handle 20 is assembled, to complete thru-holes 19 for the sexed bolts 12, 13 and female screw 11. Center piece 4 may have at least one, and in one embodiment four, complex openings, that may be generally ovoid or tear-shaped, to reduce the weight and/or improve the balance of handle 20. The outer edges of these openings may generally follow the contour of the openings disposed on the left 3 and right 2 handle pieces.

The profile of center piece 4 may be larger and/or wider than the profile of left 3 and right 2 handle pieces, so that when handle 20 is assembled, center piece 4 may protrude beyond at least one of the top, bottom, and/or posterior surfaces of handle pieces 3 and 2. To enhance the comfort of handle 20, an outer surface of center piece 4 may have filleted edges and/or a slight bulge.

Head 1 comprises a single piece of machined/milled 316 stainless steel, or any other suitable material, such as, but not limited to, titanium, gold, platinum, and iridium or any combination thereof, that may be machine polished to a satin finish to match left 3 and right 2 handle pieces. Head 1 may be generally rectangular in shape and possess at least one large, generally rectangular opening through the middle. On its underside, head 1 may have at least one cavity 24 into which magnet 14 is affixed with adhesive or by any other suitable manner. Magnet 14 may be comprised of nickel-plated rare earth magnets or any other suitable magnet.

Cartridge 30 sub-assembly comprises at least one blade 10 described above, although it's possible blade 10 may be comprised of diamond or any other suitable material. Blade 10 is sandwiched between cartridge top 5 and cartridge bottom 6, which may be machined from 316 stainless steel or any other suitable material such as, but not limited to, titanium, gold, platinum, and iridium or any combination thereof and may be mechanically polished to satin finish, matching left 3 and right 2 handle pieces and/or head 1. Cartridge bottom 6 has at least one large generally rectangular opening in the center. Cartridge top 5 has a similar opening, plus at least one, and in one embodiment, two transverse struts 32 which match the angle of left 3 and right 2 handle pieces, and which provide support for the back surface of blade 10.

Cartridge bottom 6 may have at least two tapped holes 29 adapted to receive microscrews 16. Cartridge top 5 may have at least two thru-holes 28, or the same number of tapped holes 29 disposed in cartridge bottom 6, adapted for the insertion of microscrews 16. Cartridge bottom 6 and top 5 are attached to each other via microscrews 16. Microscrews 16 may be comprised of stainless steel or any other suitable material such as, but not limited to, titanium, gold, platinum and iridium or any combination thereof, the shafts of which pass through hole 28 in cartridge top 5 and are secured and screw into matching and/or aligning tapped holes 29 in cartridge bottom 6 from above, thereby securing cartridge top 5 to cartridge bottom 6 and securing blade 10 in assembled cartridge 30.

In addition, cartridge top 5 may have at least one well 24 to receive rare earth magnet 15 in the opposite polar orientation to magnet 14 disposed in well 24 on head 1, allowing cartridge assembly 30 to attach to head 1. To prevent cartridge 30 from shearing off from head 1 during shaving or incidental contact, head 1 and cartridge 30 may have several interlocking surfaces oriented perpendicular to the face plane, horizontally, vertically, and/or both.

### EXAMPLE

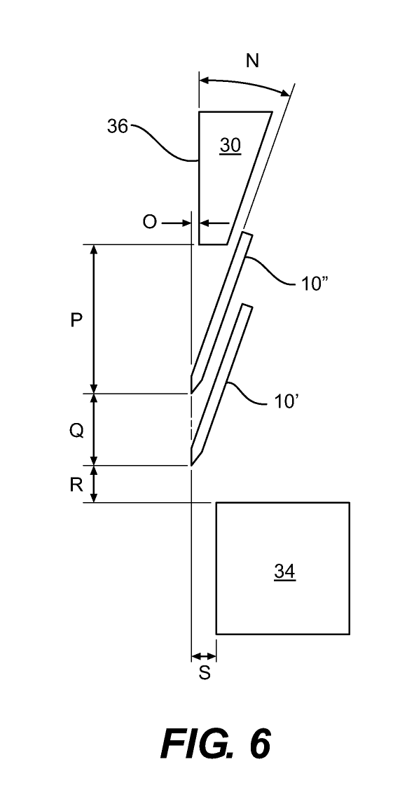

The following values are exemplary only, and are based on an embodiment of the present invention having two blades 10. As shown in FIG. 6, blades 10 comprised of first blade 10′ and second blade 10″ are held in cartridge 30 so that they are oriented at angle N of about 18 degrees to about 20 degrees, and in one embodiment about 19 degrees from the front face 36 of cartridge 30. First blade 10′ is located at a distance R of about 0.83 mm to about 0.94 mm and in one embodiment about 0.889 mm from the trailing edge of guard bar 34, and is exposed at a distance S of approximately 0.6 mm (when viewed along the face plane). Second blade 10″ is located at a distance Q of about 1.6 mm to about 1.8 mm and in one embodiment about 1.7 mm from first blade 10′, at the same exposure. The [leading edge of top bar 36] is located at a distance P of about 3.4 mm to about 3.6 mm and in one embodiment about 3.515 mm from the tip of second blade 10″, and at a distance O of about 0.13 mm to about 0.24 mm and in one embodiment about 0.186 mm back from the plane created by the two blade 10 edges.

Referring back to FIG. 5, one pivot pin 7 is inserted into clockwise wound torsion spring 8. A first leg of torsion spring 8 is inserted into a slot (not shown) on pivot pin 7. Spring 8 and pivot pin 7 subassembly is then inserted into cavity 22 disposed on or near first end 26 of left handle piece 3 and rotated so that a second leg of torsion spring 8 is inserted into a milled hole (not shown) at the base of cavity 22. Left handle piece 3 is then mated to head 1 by inserting pivot pin 7 into hole 23 in head 1. A second pivot pin 7, counter-clockwise wound torsion spring 9, and right handle piece 2 are assembled in the same manner, respectively. Center piece 4 is then placed between right 2 and left 3 handle pieces and sexed bolts 12, 13 are then inserted in the front and rear thru-holes 19, and secured with removable female screws 11. Head 1 and handle 20 are thereby connected, with sprung pivoting pins 7 between head 1 and handle 20.

Cartridge 30 attaches to head 1 via magnets 14, 15 attached to cartridge 30 and head 1. At least one magnet 14 may be disposed on each of head 1 and a matching number of magnets 15 on a first or top surface of cartridge top 5. As head 1 and cartridge 30 are brought together, the attraction of magnets 14, 15 will cause them to align and pull together. As head 1 and cartridge 30 come together, interlocking surfaces on the two will prevent cartridge 30 from shearing away from head 1 during normal usage.

In an embodiment, Applicant's solid white sapphire blades are hypoallergenic, substantially impervious to oxidation and corrosion, and may be an order of magnitude more durable than any other known shaving blade.

In an embodiment, Applicant's substrate 17 are sapphire blades that may be sharpened with high-energy, ionized particles creating a tip less than about 100 atoms in width, or roughly 5000 times smaller than the width of a hair.

In an embodiment, Applicant's custom hexagonal screws may be precision machined from pure platinum.

Numerous characteristics and advantages have been set forth in the foregoing description, together with details of structure and function. The novel features are pointed out in the appended claims. The disclosure, however, is illustrative only, and changes, may be made in detail, especially in matters of shape, size, and arrangement of parts, within the principle of the invention, to the full extent indicated by the broad general meaning of the terms in which the appended claims are expressed.

What is claimed is:

1. A razor blade comprising:
a mineral substrate;
an adhesion promoter having a first surface bound to the mineral substrate; and
the adhesion promoter having a second surface bound to an outer layer.

2. The razor blade according to claim 1, wherein the mineral is diamond.

3. The razor blade according to claim 1, wherein the mineral is corundum.

4. The razor blade according to claim 2, wherein the corundum is sapphire.

5. The razor blade according to claim 1, wherein the adhesion promoter first surface comprises a substrate binding group and the adhesion promoter second surface comprises an outer layer binding group.

6. The razor blade according to claim 5, wherein the adhesion promoter substrate binding group comprises a silane.

7. The razor blade according to claim 5, wherein the adhesion promoter substrate binding group comprises a phosphonate.

8. The razor blade according to claim 5, wherein the adhesion promoter outer layer binding group comprises a halogen.

9. The razor blade according to claim 5, wherein the adhesion promoter outer layer binding group comprises an amine.

10. The razor blade according to claim 1, wherein the outer layer is a lubricious fluoropolymer.

11. A razor blade comprising:
a mineral blade having a mineral cutting edge;
the mineral cutting edge having a radius of less than about 20 nanometers and an angle of about 40-50 degrees;
wherein the corundum blade is coated in about 20 nanometers of adhesion promoter and at least about 400 nanometers of outer layer.

12. A razor comprising at least one blade according to claim 1, further comprising:
a head having a first surface and a second surface;
a cartridge having a cartridge top having a first surface and a second surface and a cartridge bottom having a first surface and a second surface;
wherein the blade is disposed between the second surface of the cartridge top and the first surface of the cartridge bottom;
wherein the first surface of the cartridge top is removably attached to the second surface of the head; and
a handle, wherein the head is movably attached by a pivot pin to a first end of the handle.

13. The razor according to claim 11, wherein the first surface of the cartridge top is removably attached to the second surface of the head using at least one magnet.

14. The razor according to claim 11, wherein the handle is comprised of a left piece having an internal and an external surface, a right piece having an internal and an external surface, and a center piece, wherein the center piece is disposed between the internal surface of the left piece and the internal surface of the right piece.

15. The razor according to claim 11, wherein the cartridge is comprised of:
a cartridge top having a first surface and a second surface;
a cartridge bottom having a first surface and a second surface;
wherein the blade is disposed between the second surface of the cartridge top and the first surface of the cartridge bottom;
wherein the cartridge top is attached to the cartridge bottom using at least one micro-screw; and
wherein at least one cavity is disposed in the first surface of the cartridge top, wherein the cavity is adapted to receive at least one magnet.

16. The razor according to claim 13, wherein the magnet is a rare earth magnet.

17. The razor according to claim 13, wherein the magnet is a nickel-plated rare earth magnet.

18. The razor according to claim 13, wherein at least one first magnet is disposed on the head and at least one second magnet of opposite polar orientation from the first magnet is disposed on the first surface of the cartridge top.

19. The razor according to claim 14, wherein the center piece is comprised of at least one of iridium, platinum, titanium and gold or a combination thereof.

20. The razor according to claim 11, wherein the razor comprises at least two mineral blades.

21. A method for sharpening blades comprising the use of plasma sharpening.

22. A method for sharpening blades comprising the use of a laser.

23. A razor comprising:
a handle;
a head attached to the handle; and
a cartridge containing a blade;
wherein the cartridge is removably attached to the head by at least one magnet.
